(19) United States
(12) Patent Application Publication
(10) Pub. No.: US 2014/0310549 A1
(43) Pub. Date: Oct. 16, 2014

(54) FIFO Clock and Power Management

(71) Applicant: APPLE INC., Cupertino, CA (US)

(72) Inventor: Gilbert H. Herbeck, Livermore, CA (US)

(73) Assignee: Apple Inc., Cupertino, CA (US)

(21) Appl. No.: 13/861,071

(22) Filed: Apr. 11, 2013

(51) Int. Cl. G06F 1/32

(52) U.S. Cl. CPC G06F 1/324
USPC 713/322

(57) ABSTRACT

An apparatus and method for saving power when transmitting data across a clock boundary is disclosed. In one embodiment, an apparatus includes a FIFO coupled to receive data from circuitry in a first clock domain and output data to circuitry in a second clock domain. A first control circuit is responsible for writing data into the FIFO. A second control circuit is responsible for reading data from the FIFO. If the amount of data in the FIFO exceeds a first threshold, a power management circuit may place the first control circuit in a low power state. The second control circuit may monitor the amount of data in the FIFO. If the amount of data in the FIFO falls below a second threshold, it may assert an indication to the power management circuit. Thereafter, the power management circuit may cause the first control circuit to exit the low power state.

### BACKGROUND

1. Technical Field

This disclosure is directed to electronic systems, and more particularly, to power savings in electronic systems.

2. Description of the Related Art

Many modern integrated circuits (ICs) are divided into various clock and power domains. A clock domain may be generally defined as a group of circuits that operate according to the same clock signal. Similarly, a power domain may be generally defined as a group of circuits that operate at a common voltage. In some cases, power domains and clock domains may overlap in their entirety, although this is not an absolute requirement. Utilizing clock and power domains may allow circuitry to operate with more efficiency in terms of both power and performance.

During operation of ICs having multiple power and/or clock domains, it is often times necessary to transfer signals from one domain to another. For example, signals carrying information may be transferred from a circuitry in a clock domain operating at a first clock frequency to circuitry in another clock domain operating at a second clock frequency that is different from the first. To accomplish such transfers, various types of synchronization circuitry may be employed. In cases where significant amounts of data are to be transferred across a clock boundary (i.e. the boundary between one clock domain and another), a first-in, first-out memory (FIFO) may be included in the synchronization circuitry. Data may be written into the FIFO according to the clock signal of the input clock domain and read therefrom according to the clock signal of the output clock domain.

### SUMMARY

An apparatus and method for saving power when transmitting data across a clock boundary is disclosed. In one embodiment, an apparatus includes a first-in, first-out memory (FIFO) coupled to receive data from circuitry in a first clock domain and output data to circuitry in a second clock domain. A first control circuit is responsible for writing data into the FIFO. A second control circuit is responsible for reading data from the FIFO. If the amount of data in the FIFO exceeds a first threshold, a power management circuit may place the first control circuit in a low power state. The second control circuit may monitor the amount of data in the FIFO. If the amount of data in the FIFO falls below a second threshold, it may assert an indication to the power management circuit. Thereafter, the power management circuit may cause the first control circuit to exit the low power state.

In one embodiment, a method includes writing data into a FIFO by a first controller operating according to a first clock frequency (and in a first clock domain). The method further includes reading data from the FIFO by a second controller operating according to a second clock frequency (and in a second clock domain). The first controller is placed in a low power state if the amount of data is greater than a first threshold. If the amount of data in the FIFO falls below a second threshold, the first controller may be awakened from the low power state.

The method and apparatus described herein may be used in various embodiments in which data is transferred between two different clock domains. Furthermore, the method and apparatus described herein may be particularly useful in situations where the frequencies of the respective clock signals of the clock domains are different from one another. For example, if the clock frequency of the domain from which data is written to the FIFO is greater than that of the domain to which data is read into, it may be possible to write data to the FIFO faster than it can be read. Accordingly, the FIFO controller in the writing domain may write a certain amount of data to the FIFO until the first threshold is exceeded, and then be placed in a low power state until enough data has been read that the amount of unread date in the FIFO is below a second threshold. When the amount of unread data in the FIFO is below the second threshold, the FIFO controller in the writing domain may be awakened and may begin writing data to the FIFO once again.

The apparatus and methods described herein may also work in the reverse order. For example, if data can be read from the FIFO faster than it can be written thereto, the FIFO controller in the reading domain may read data until the amount of unread data in the FIFO falls below a lower threshold. At this point, the FIFO controller in the reading domain may discontinue reading, and may be placed in a low power state. The FIFO in the writing domain may continue writing data into the FIFO. Once the amount of unread data in the FIFO exceeds an upper threshold, the FIFO controller in the reading domain may be activated once again and may begin reading data.

### BRIEF DESCRIPTION OF THE DRAWINGS

The following detailed description makes reference to the accompanying drawings, which are now briefly described.

FIG. 1 is a block diagram of one embodiment of an integrated circuit having multiple clock domains.

FIG. 2 is a block diagram illustrating one embodiment of an apparatus for transferring data across a clock boundary.

FIG. 3 is a flow diagram of one embodiment of a method for saving power in an apparatus for transferring data across a clock boundary.

FIG. 4 is a flow diagram of another embodiment of a method for saving power in an apparatus for transferring data across a clock boundary.

FIG. 5 is a block diagram of one embodiment of an exemplary system.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims. The headings used herein are for organizational purposes only and are not meant to be used to limit the scope of the description. As used throughout this application, the word “may” is used in a permissive sense (i.e., meaning having the potential to), rather than the mandatory sense (i.e., meaning must). Similarly, the words “include”, “including”, and “includes” mean including, but not limited to.

Various units, circuits, or other components may be described as “configured to” perform a task or tasks. In such contexts, “configured to” is a broad recitation of structure generally meaning “having circuitry that” performs the task or tasks during operation. As such, the unit/circuit/component can be configured to perform the task even when the unit/circuit/component is not currently on. In general, the circuitry that forms the structure corresponding to “configured to” may include hardware circuits. Similarly, various units/circuits/components may be described as performing a task or tasks, for convenience in the description. Such descriptions should be interpreted as including the phrase “configured to.” Reciting a unit/circuit/component that is configured to perform one or more tasks is expressly intended not to invoke 35 U.S.C. §112, paragraph six interpretation for that unit/circuit/component.

### DETAILED DESCRIPTION OF EMBODIMENTS

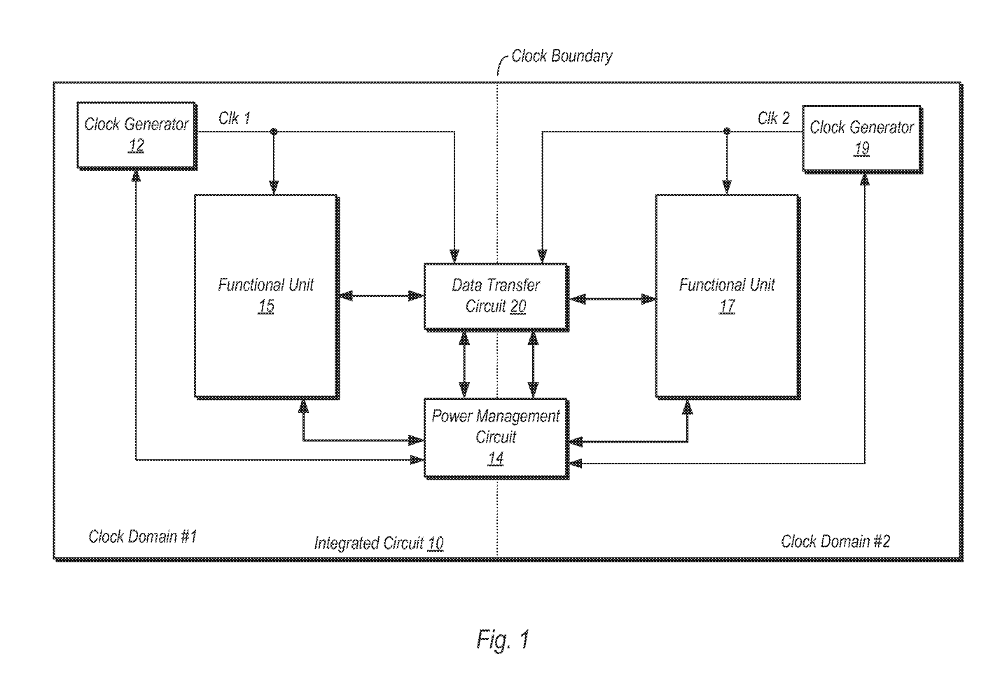

Turning now to FIG. 1, a block diagram of one embodiment of an integrated circuit (IC) having multiple clock domains is shown. It is noted that the diagram shown here is for illustrative purposes, and is not meant to limit the disclosure. Embodiments having more than two clock domains as well as additional features are thus possible and contemplated.

In the embodiment shown, IC 10 includes two clock domains. Circuitry in Clock Domain #1 is coupled to receive a first clock signal, Clk1, from clock generator 12. Circuitry in Clock Domain #2 is coupled to receive a second clock signal, Clk2. In some embodiments, the respective frequencies of Clk1 and Clk2 may be different. Furthermore, the frequencies of these clock signals may in some embodiment be variable (e.g., for power saving purposes). Thus it is possible in such embodiments that at times Clk1 will have a higher frequency than Clk2, while at other times Clk2 will have a higher frequency than Clk1.

Clock Domain #1 of IC 10 includes a first functional unit 15, while Clock Domain #2 includes a second functional unit 17. Functional unit 15 is thus synchronized to Clk1, while functional unit 17 is synchronized to Clk2. The operations performed by these functional units may vary from one embodiment to the next, and it is noted that other functional units may be present in one or both of the clock domains.

During operation of IC 10, there may be a need for communications between functional unit 15 and functional unit 17. In the embodiment shown, IC 10 includes a data transfer circuit 20 configured to perform transfers of data across the boundary between Clock Domain #1 and Clock Domain #2. Data transfer circuit 20 in the embodiment shown is configured to perform bi-directional data transfers between the two functional units. As is discussed in further detail below, data transfer circuit 20 may implement first-in, first-out memories (FIFOs) for transferring data from one clock domain to the other. Data may be written into a FIFO in one clock domain synchronous with its respective clock signal. The data may be read from the FIFO in the other clock domain synchronous with its respective clock signal.

IC 10 in the embodiment shown also includes a power management circuit 14. Power management circuit 14 may perform various power management functions, including clock gating and/or power gating various portions of IC 10 in order to achieve power savings. In particular, if a portion of IC 10 is idle and is not otherwise needed to complete a pending transaction, it may be placed in a low power state. One low power state may be attained by clock gating the idle portion of the circuitry. Clock gating may be defined herein as inhibiting a clock signal from being provided to the circuitry of the idle portion. This may save dynamic power that might otherwise be wasted on idle circuitry. Another low power state may be achieved by power gating the idle circuitry. Power gating may be defined as inhibiting power (by inhibiting a corresponding supply voltage) from being provided to the idle circuitry. It is noted that in many cases, circuitry that is power gated may also be clock gated. Clock gating and/or power gating may be performed at various levels, including on the entirety of functional units 15 and 17 themselves, to individual circuits within these functional units, and to the data transfer circuit 20, and to individual portions thereof.

Since it is possible that the data rates at which data may be written into a FIFO of data transfer circuit may differ from the data rates at which data may be read therefrom (e.g., due to differences in the respective clock frequencies), power management circuit 14 may in some cases place portions of data transfer circuit 20 into a low power state. For example, if data is being written into the FIFO from one clock domain faster than it is being read out of the FIFO in the other clock domain, power management circuit 14 may place circuitry on the write side of the data transfer circuit 20 into a low power state until such time it is required to write more data. In another example, if data is being read from the FIFO faster than it can be written, power management circuit 14 may place circuitry on the read side of the data transfer circuit 20 into a low power state. The circuitry on the read side of data transfer circuit 20 may remain in the low power state until the FIFO has been replenished to a certain level, which may be predefined. In general, since data cannot be written to a FIFO that is full or read from a FIFO that is empty, power management of the read and/or write sides of data transfer circuit 20 may be performed in order that power is conserved while also preventing an overflow or under run of a FIFO involved in a data transfer.

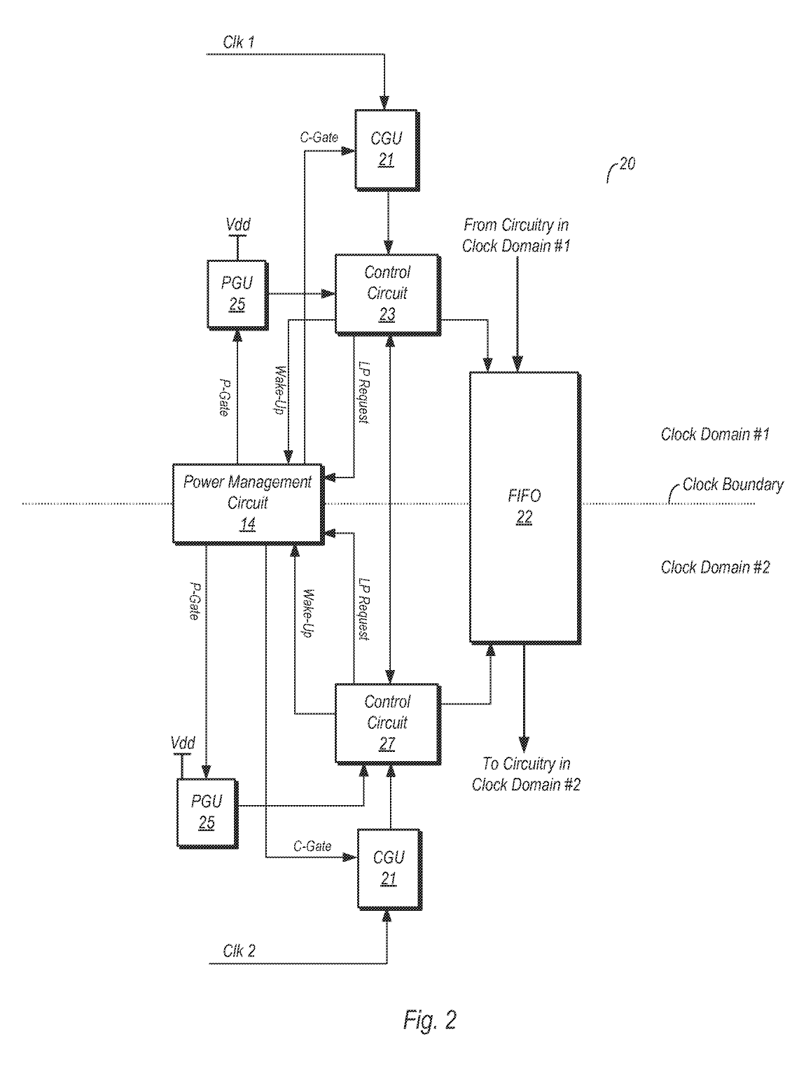

FIG. 2 is a block diagram of one embodiment of data transfer circuit 20. In the embodiment shown, data transfer circuit 20 includes a FIFO 22 used in transferring data from Clock Domain #1 to Clock Domain #2. Although not explicitly shown, embodiments of data transfer circuit 20 could also include a second FIFO for transferring data from Clock Domain #2 to Clock Domain #1. Alternatively, a separate data transfer circuit could be implemented to perform such a transfer.

Control circuit 23 is configured to control the writing of data to FIFO 22. Similarly, control circuit 27 is configured to control the reading of data from FIFO 22. Accordingly, control circuit 23 may control a write pointer for FIFO 22. Similarly, control circuit 27 may control a read pointer for FIFO 22. Each of the control circuits may monitor the position of both pointers. The relative position of the read and write pointers may be used to determine the amount of unread data currently stored in FIFO 22.

As noted above, it is possible that the rate at which data is written to FIFO 22 may not be the same as the rate at which data is read therefrom. These mismatches in data rates may occur for a number of different reasons. For example, a difference in the respective frequencies of Clk1 and Clk2 may result in different rates of input and output to FIFO 22. Thus, if the clock frequency of Clk1 is greater than that of Clk2, it is possible that data may be written into FIFO 22 faster than it is read therefrom. Conversely, if the clock frequency of Clk1 is less than that of Clk2, data may be read from FIFO 22 faster than it is written thereto.

Another cause of different data rates between the input and output sides of FIFO 22 may be due to differences in the bandwidth of transmitting and receiving circuitry. For example, circuitry in Clock Domain #1 may be capable of transferring data to FIFO 22 at a first data rate while circuitry in Clock Domain #2 is capable of receiving data from FIFO 22 at a second data rate. A mismatch in these bandwidths may thus result in difference in the rates at which data can be written to and read from FIFO 22. Other possible causes of different data rates between the input and output sides of FIFO 22 may include temporary congestion due to competition for resources, interrupts, and so forth.

Mismatches between the rates at which data can be written to and read from FIFO 22 may give rise to opportunities to save power. For example, when data is being written to FIFO 22 faster than it is being read therefrom, the writing of data may be suspended in order to prevent the write pointer from overtaking the read pointer (and thus preventing the overwriting of unread data). Accordingly, while waiting for the resumption of data writing, control circuit 23 may be placed in a low power state by either clock gating or power gating. During the time control circuit 23 is in the low power state, some responsibility for controlling the data transfer may be transferred to control circuit 27.

In one embodiment, when the amount of unread data in FIFO 22 exceeds a predefined high threshold, power management circuit 14 may place control circuit 23 in a low power state. In the embodiment shown, control circuit 23 is configured to assert a request signal (‘IP Request’) to power management circuit 14. Additionally, control circuit 23 may communicate its status to control circuit 27, indicating that it is to enter a low power state. Responsibility for monitoring the amount of data present in FIFO 22 may thus be assumed in full by control circuit 27 and maintained during the time that control circuit 23 is in the low power state. Control circuit 27 may also continue causing data to be read from FIFO 22 during this time. When the amount of unread data in FIFO 22 falls below a predefined low threshold, control circuit 27 may assert a wake-up signal that is received by power management unit 14. Responsive to receiving the wake-up signal from control circuit 27, power management unit 14 may cause control circuit 23 to exit the low power state. Thereafter, control circuit 23 may resume its duties in causing data to be written into FIFO 22.

Control circuit 27 may be placed in a low power state in some instances if the rate at which data is read from FIFO 22 exceeds the rate at which data is written thereto. In such a situation, control circuit 27 may assert a request signal to power management circuit 14 when the amount of unread data in FIFO 22 falls below a predefined low threshold. Control circuit 27 may also provide to control circuit 23 an indication of its pending entry into the low power state. Control circuit 23 may assume some responsibilities of control circuit 27, including the monitoring of the amount of unread data present in FIFO 22. When control circuit 23 determines that the amount of unread data in FIFO 22 is above the predefined high threshold, it may assert a wake-up signal to power management circuit 14. Responsive to receiving the wake-up signal, power management unit 14 may cause control circuit 27 to exit the low power state. Thereafter, control circuit 27 may resume its duties in causing data to be read from FIFO 22.

As noted above, power management circuit 14 may place a control circuit into a low power state by power gating, clock gating, or both. In the embodiment shown, control circuits 23 and 27 are coupled to respective instances of a power gating unit 25 and a clock gating unit 21. Power management unit 14 may clock gate a control circuit by asserting a clock gating signal (‘C-Gate’) to its respectively coupled clock gating unit 21. This may cause the clock gating unit 21 to inhibit its respectively received clock signal from being provided to its respectively coupled control circuit. For example, asserting a clock gating signal in Clock Domain #1 may cause the corresponding clock gating unit 21 to inhibit Clk1 from being provided to control circuit 23. When the clock gating signal is de-asserted, the respectively received clock signal may pass through the clock gating unit 21 to its respectively coupled control circuit.

Power gating of a control circuit may be accomplished by power management circuit 14 by asserting a power gating signal (‘P-Gate’) to a power gating unit 25. When an asserted power gating signal is received by a power gating unit, it may inhibit a supply voltage (‘Vdd’ in this example) from being provided to its respectively coupled control circuit. For example, if the power gating signal in Clock Domain #2 is asserted, the corresponding power gating unit 25 may inhibit Vdd from being provided to control circuit 27. When the power gating signal is de-asserted, the receiving power gating unit 25 may allow the supply voltage to be provided to its correspondingly coupled control circuit.

In some embodiments, power management unit 14 may clock gate or power gate a control circuit based on the amount of time it is expected to remain in the low power state until a wake up signal is asserted by the other control circuit. If the expected time in the low power state is relatively short (e.g., when the mismatch between data rates is relatively small), power management circuit 14 may choose to clock gate the control circuit. If the time is expected to be relatively long (e.g., when the mismatch between data rates is relatively large), power management circuit may choose to power gate the control circuit. It is further noted that in some cases, clock gating may be performed along with power gating.

In addition to performing clock and/or power gating on the control circuits as described above, functional units 15 or 17 or various circuits internal thereto may also be placed in a low power state during a data transfer as described above. For example, if control circuit 23 is in a low power state during the transfer of data from clock domain #1 to clock domain #2, part or all of functional unit 15 may also be placed in a low power state if not otherwise busy performing other work. This may significantly increase the amount of power saved during the transfer of data across a clock boundary.

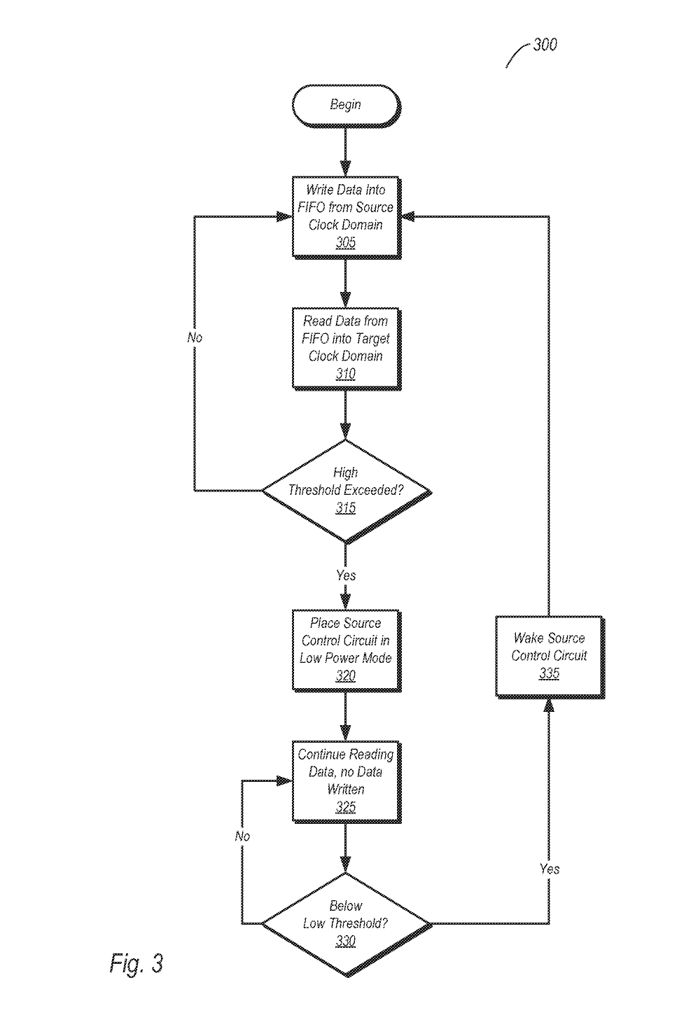

FIG. 3 is a flow diagram of one embodiment of a method for saving power in an apparatus for transferring data across a clock boundary. Method 300 in the embodiment shown may be performed on various embodiments of the hardware discussed above. Additionally, method 300 may also be performed on other hardware embodiments not explicitly discussed herein.

Method 300 is generally directed to embodiments or situations within a given embodiment in which the rate at which data is written to the FIFO exceeds that at which it is read from the FIFO. The method begins with the writing of data into a FIFO from circuitry in a source clock domain (block 305). The source clock domain may be defined herein as the clock domain having the circuitry from which data is being transferred. The method further comprises reading data from the FIFO in a target clock domain (block 310). The target clock domain may be defined herein as the clock domain having the circuitry to which data is being transferred. If the amount of unread data in the FIFO does not exceed a predefined high, or upper threshold (block 315, no), then the method returns to block 305, and this loop may be repeated. If the amount of unread data in the FIFO exceeds the high threshold (block 315, yes), then the control circuit in the source clock domain may be placed into a low power state (block 320).

With the control circuit in the source clock domain in a low power state, the control circuit in the target clock domain may assume some of its responsibilities, including monitoring the amount of unread data in the FIFO. Data may continue being read from the FIFO under the control of the control circuit in the target clock domain (block 325). No data is written to the FIFO while the control circuit in the source clock domain is in the low power state.

If the control circuit in the target clock domain determines that the amount of unread data remains above a predefined low threshold (block 330, no), the method returns to block 325 and performs another iteration of that loop. If the control circuit in the target clock domain determines that the amount of unread data in the FIFO has fallen below the low threshold (block 330, yes), then it may assert a wake up signal that begins a chain of events to wake up the control circuit in the source clock domain (block 335). The method then returns to block 305.

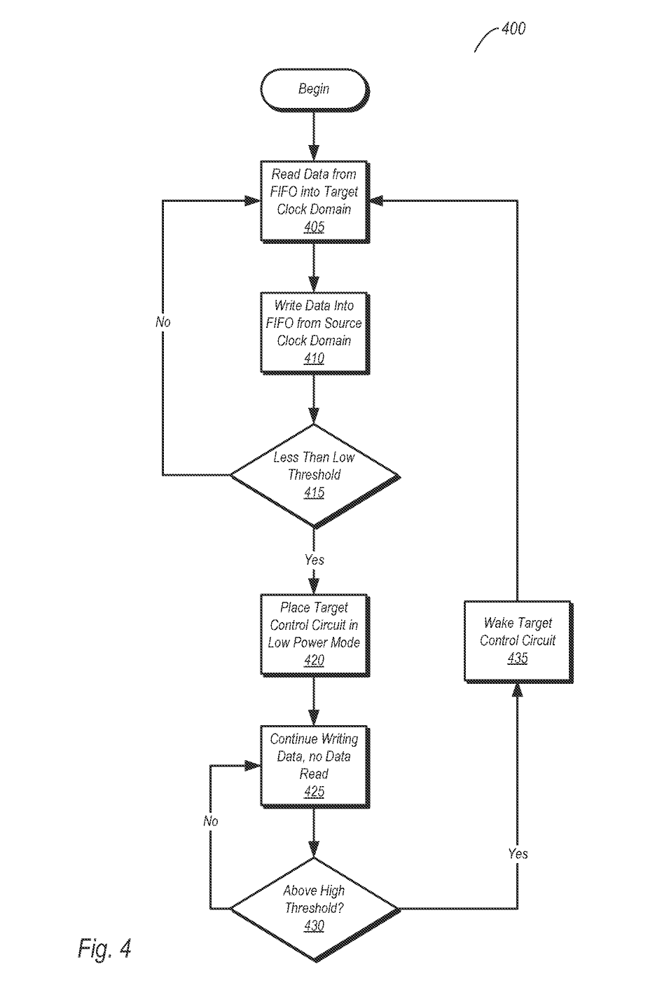

FIG. 4 is a flow diagram of one embodiment of a method for saving power in an apparatus for transferring data across a clock boundary. Method 400 in the embodiment shown may be performed on various embodiments of the hardware discussed above. Additionally, method 400 may also be performed on other hardware embodiments not explicitly discussed herein.

In contrast to method 300, method 400 is generally directed to embodiments or situations within a given embodiment in which the rate at which data is being read from the FIFO exceeds that at which it is being written to the FIFO. Method 400 begins with the reading of data in the target clock domain (block 405), and the writing of data to the FIFO in the source clock domain (block 410). If the amount of unread data in the FIFO is not less than a predefined low threshold (block 415, no), the method returns to block 405 and another iteration of the loop is performed. If the amount of unread data in the FIFO is less than the low threshold (block 415, yes), then the control circuit in the target clock domain may be placed in a low power state (block 420).

When the control circuit in the target clock domain is in the low power state, some of its responsibilities (including monitoring the amount of unread data in the FIFO) may be fully assumed by the control circuit in the source clock domain. The writing of the data to the FIFO may continue (block 425). Reads from the FIFO are suspended when the control circuit in the target clock domain is in the low power state.

If the amount of unread data in the FIFO remains less than a predefined high threshold (block 430, no), then the method returns to block 425, as writes to the FIFO are continued while reads therefrom remain suspended. If the amount of unread data in the FIFO rises to a level at which it exceeds the high threshold (block 430, yes), the control circuit in the source clock domain may assert a wake up signal. Responsive thereto, the control circuit in the target clock domain may be awakened from the low power state (block 435). Thereafter, the method returns to block 405.

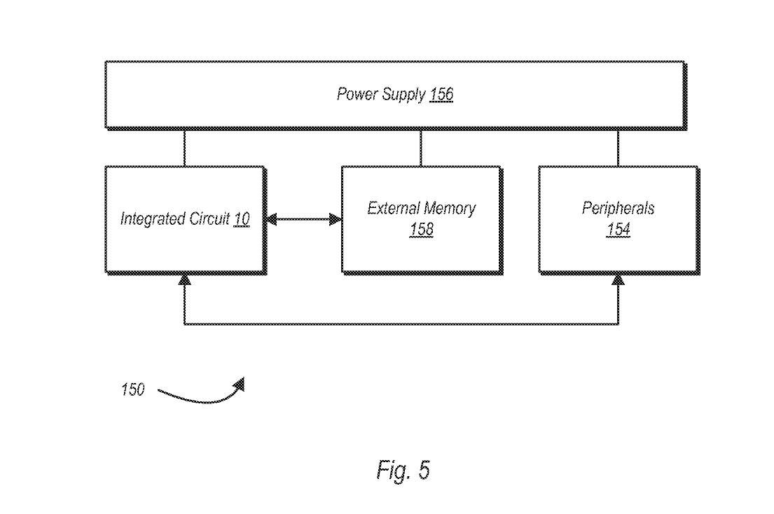

Turning next to FIG. 5, a block diagram of one embodiment of a system 150 is shown. In the illustrated embodiment, the system 150 includes at least one instance of the integrated circuit 10 coupled to external memory 158. The integrated circuit 10 is coupled to one or more peripherals 154 and the external memory 158. A power supply 156 is also provided which supplies the supply voltages to the integrated circuit 10 as well as one or more supply voltages to the memory 158 and/or the peripherals 154. In some embodiments, more than one instance of the integrated circuit 10 may be included (and more than one external memory 158 may be included as well).

The peripherals 154 may include any desired circuitry, depending on the type of system 150. For example, in one embodiment, the system 150 may be a mobile device (e.g. personal digital assistant (PDA), smart phone, etc.) and the peripherals 154 may include devices for various types of wireless communication, such as WiFi, Bluetooth, cellular, global positioning system, etc. The peripherals 154 may also include additional storage, including RAM storage, solid-state storage, or disk storage. The peripherals 154 may include user interface devices such as a display screen, including touch display screens or multitouch display screens, keyboard or other input devices, microphones, speakers, etc. In other embodiments, the system 150 may be any type of computing system (e.g. desktop personal computer, laptop, workstation, net top etc.).

The external memory 158 may include any type of memory. For example, the external memory 158 may be SRAM, dynamic RAM (DRAM) such as synchronous DRAM (SDRAM), double data rate (DDR, DDR2, DDR3, LPDDR1, LPDDR2, etc.) SDRAM, RAMBUS DRAM, etc. The external memory 158 may include one or more memory modules to which the memory devices are mounted, such as single inline memory modules (SIMMs), dual inline memory modules (DIMMs), etc.

Numerous variations and modifications will become apparent to those skilled in the art once the above disclosure is fully appreciated. It is intended that the following claims be interpreted to embrace all such variations and modifications.

What is claimed is:

1. An apparatus comprising:
a first-in, first-out memory (FIFO) coupled to receive data from circuitry operating according to a first clock signal having a first frequency and further coupled to output data to circuitry operating according to a second clock signal having a second frequency;
a first FIFO controller in the first clock domain, wherein the first FIFO controller is configured to cause data to be written into the FIFO;
a second FIFO controller in the second clock domain, wherein the second FIFO controller is configured to cause data to be read from the FIFO; and
a power management unit, wherein the power management unit is configured to place the first FIFO controller into a low power state responsive to determining that the amount of data in the FIFO exceeds a first threshold, and further configured to wake the first FIFO controller from the low power state responsive to receiving an indication from the second FIFO controller.

2. The apparatus as recited in claim 1, wherein the second FIFO controller is configured to assert the indication responsive to determining that an amount of data in the FIFO is below a second threshold.

3. The apparatus as recited in claim 1, wherein the first FIFO controller is configured to, when active, control a write pointer and the second FIFO controller is configured to control a read pointer, and wherein the second FIFO controller is further configured to determine the amount of data in the FIFO, when the first FIFO controller is in the low power state, by determining a position of the write pointer relative to the read pointer.

4. The apparatus as recited in claim 1, wherein the power management unit is configured to place the first FIFO controller in the low power state by gating the first clock signal.

5. The apparatus as recited in claim 1, wherein the power management unit is configured to place the first FIFO controller in the low power state by removing a supply voltage provided to the first FIFO controller.

6. The apparatus as recited in claim 1, wherein the first FIFO controller is configured to, when active, monitor the amount of data present in the FIFO.

7. The apparatus as recited in claim 1, wherein the first clock frequency is greater than the second clock frequency.

8. The apparatus as recited in claim 1, wherein the power management unit is configured to place into a low power state one or more additional circuits in the first clock domain responsive to determining that the amount of data in the FIFO exceeds the first threshold.

9. A method comprising:
writing data into a first-in first-out memory (FIFO), wherein said writing is performed by a first FIFO controller operating according to a first clock frequency;
reading data from the FIFO, wherein said reading is performed by a second FIFO controller operating at a second clock frequency;
placing the first FIFO controller into a low power state if the amount of data in the FIFO exceeds a first threshold; and
waking the first FIFO controller from the low power state if the amount of data in the FIFO falls below a second threshold.

10. The method as recited in claim 9, further comprising:
asserting, using the second FIFO controller, an indication responsive to determining that the amount of data in the FIFO has fallen below the second threshold;
a power management unit receiving the indication; and
the power management unit waking the first FIFO controller from the low power state responsive to receiving the indication.

11. The method as recited in claim 9, wherein the first clock frequency is greater than the second clock frequency.

12. The method as recited in claim 9, further comprising the second FIFO controller monitoring the amount of data in the FIFO responsive to the first FIFO controller being placed in the low power state.

13. The method as recited in claim 9, wherein placing the first FIFO controller in the low power state comprises one or more of the following:
clock-gating the first FIFO controller;
power-gating the first FIFO controller.

14. The method as recited in claim 9, further comprising:
the second FIFO controller determining the amount of data in the FIFO; and
the second FIFO controller asserting an indication that the amount of data in the FIFO is below the second threshold.

15. An integrated circuit comprising:
a first control circuit configured to cause data to be written into a first-in, first-out memory (FIFO), wherein the first controller is configured to operate synchronous with a first clock signal having a first frequency;
a second control circuit configured to cause data to be read from the FIFO, wherein the second controller is configured to operate synchronous with a second clock signal having a second frequency; and
a power management circuit configured to place the first control circuit in a low power state responsive to an amount of data in the FIFO exceeding a first threshold, and further configured to wake the first control circuit from the low power state responsive to receiving a first indication that the amount of data in the FIFO is below a second threshold.

16. The integrated circuit as recited in claim 15, wherein the second control circuit is configured to determine the amount of data stored in the FIFO when the first controller is in a low power state, and further configured to assert the indication responsive to determining that the amount of data stored in the FIFO has fallen below the second threshold.

17. The integrated circuit as recited in claim 15, wherein the first control circuit is configured to, when active, determine the amount of data stored in the FIFO, and further configured to provide a second indication to the power management circuit that the amount of data exceeds the first threshold.

18. The integrated circuit as recited in claim 17, wherein the power management circuit is configured to provide a third indication to the second control circuit responsive to placing the first control circuit in the low power state.

19. The integrated circuit as recited in claim 15, wherein the first control circuit is configured to, when active, control a write pointer and the second control circuit is configured to control a read pointer, and wherein the second control circuit is further configured to determine the amount of data in the FIFO, when the first FIFO controller is in the low power state, by determining a position of the write pointer relative to the read pointer.

20. The integrated circuit as recited in claim 15, the power management circuit is configured to place the first control circuit in the low power state by performing one or more of the following:
causing the first clock signal to be inhibited from being provided to the first control circuit;
causing a supply voltage to be removed from the first control circuit.
